(19) United States
(12) Patent Application Publication
(10) Pub. No.: US 2007/0079919 A1
(43) Pub. Date: Apr. 12, 2007

(54) Scouring web and method of making

(76) Inventors: Thomas E. Haskett, Oakdale, MN (US); Ana Claudia Rueda Nery Barboza, Campinas (BR); Jeffrey M. Mailand, Hudson, WI (US)

Correspondence Address: 3M INNOVATIVE PROPERTIES COMPANY, PO BOX 33427, ST. PAUL, MN, 55133-3427, US

(21) Appl. No.: 11/244,837

(22) Filed: Oct. 6, 2005

(51) Int. Cl. B29C 59/00

(52) U.S. Cl. 156/62.2; 264/122

(57) ABSTRACT

The present invention relates to a method of making a scouring web. The method of making the scouring web comprises providing a plurality of metal fibers and a plurality of polymeric fibers, combining the metal fibers with the polymeric fibers, heating the polymeric fibers so that at least a portion of the polymeric fibers melt, and cooling the polymeric fibers to solidify the portion of the polymeric fibers that melted and to secure the blend of metal fibers and polymeric fibers together.

### BACKGROUND

The present invention relates to a scouring web. In particular, the present invention relates to a web comprising a blend of metal fibers and polymeric fibers.

Metal wool pads, such as steel wool pads, have been used for a variety of household and industrial applications that require scouring or abrading a surface. Metal wool pads are typically made of steel wool strands that are skived from a metal block, which have been matted or felted together, or intertwined or interwoven into a mass of filaments. Steel wool strands are used because a low cost scouring pad can be provided to consumers.

One typical application for steel wool pads is in the household for scouring articles like pots and pans. The hardness of the metal and the sharp edges provide the scouring action and polishes the metal surfaces of the pots and pans. Steel wool pads may be provided with soap or detergent to further aid in cleaning surfaces. Another typical application for steel wool pads is performing light sanding on wood surfaces such as during wood floor refinishing.

In spite of the practical applications, metal wool and in particular steel wool pads have a number of undesirable characteristics. One problem associated with steel wool pads in particular is that the metal oxidizes and rusts. A rusted steel wool pad looks undesirable to a user for cleaning. When using a steel wool pad for sanding wood surfaces, if a splinter from the steel wool pad remains on the surface and a water-based finish is used, the splinter will rust and be trapped in the finish leaving undesirable rust stains.

Use of other metals besides steel have been attempted to avoid the problem of the metal rusting. However, metals such as stainless steel, which does not rust, are significantly more expensive than steel. Therefore, metal pads with metals such as stainless steel have been too expensive to make practical as a consumer product.

The other significant problem associated with metal wool pads is the tendency of the pads to shed metal fibers or splinters. The sharpness of the metal fibers makes the pad uncomfortable to hold. If contact is made with the metal wool pad, the splinters may enter the skin of the user and result in a metal sliver, which causes an abrasion and potential inflammation. Therefore, many consumers will hold a sponge or other soft cloth material against their hand to prevent the metal wool pad from contacting their hand. Attempts have been made to attach a substrate to the metal wool pad. However, the same problems persist: splinters still result on the surface and the steel wool rusts.

What is desired is an article having the scouring and polishing properties of steel wool but does not rust and has minimal splinters. Such a product must be low cost to make it practical for use as a consumer product for such things as scouring household materials like pots and pans or as an abrasive on wood surfaces or the like.

### SUMMARY

The present invention provides a scouring article that may use metal materials like stainless steel that do not rust in a quantity to result in a low-cost scouring article. The scouring article of the present invention may be made with metal fibers that emit minimal splinters and in some embodiments may be provided with a support layer for ease in handling.

The present invention relates a method of making a scouring web. In one embodiment, the method of making the scouring web comprises providing a plurality of metal fibers and a plurality of polymeric fibers, combining the metal fibers with the polymeric fibers, heating the polymeric fibers so that at least a portion of the polymeric fibers melt, and cooling the polymeric fibers to solidify the portion of the polymeric fibers that melted and to secure the blend of metal fibers and polymeric fibers together.

In another embodiment, the method of making a scouring article comprises providing a plurality of metal fibers, providing a plurality of polymeric fibers, combining the metal fibers with the polymeric fibers, heating the polymeric fibers so that at least a portion of the polymeric fibers melt, attaching a support layer to the metal fibers and polymeric fibers, and cooling the polymeric fibers to solidify the portion of the polymeric fibers that melted and to secure the blend of metal fibers and polymeric fibers together.

In another embodiment, the method of making a scouring article comprises providing a plurality of metal fibers, providing a plurality of polymeric fibers, combining the metal fibers with the polymeric fibers to form a web having a first surface and a second surface, heating the polymeric fibers so that at least a portion of the polymeric fibers melt, providing a support layer with a first surface and a second surface, attaching the first surface of the support layer to the second surface of the web, providing a substrate with a first surface and a second surface, attaching the first surface of the substrate to the second surface of the support layer, and cooling the polymeric fibers to solidify the portion of the polymeric fibers that melted and to secure the blend of metal fibers and polymeric fibers together.

### BRIEF DESCRIPTION OF THE DRAWINGS

FIG. 1a is a perspective view of a metal web of the present invention.

FIG. 1b is an enlarged view of the metal web of FIG. 1a.

FIG. 2 is a perspective view of a scouring article having the metal web attached to a support layer.

FIG. 3 is a cross-sectional view of the scouring article of FIG. 2.

FIG. 4 is a cross-sectional view of an alternative scouring article.

FIG. 5 is a cross-sectional view of an alternative scouring article.

FIG. 6 is a side view of an exemplary process of making the scouring article of FIG. 2.

While the above-identified drawings and figures set forth embodiments of the invention, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of this invention. The figures may not be drawn to scale.

### DETAILED DESCRIPTION

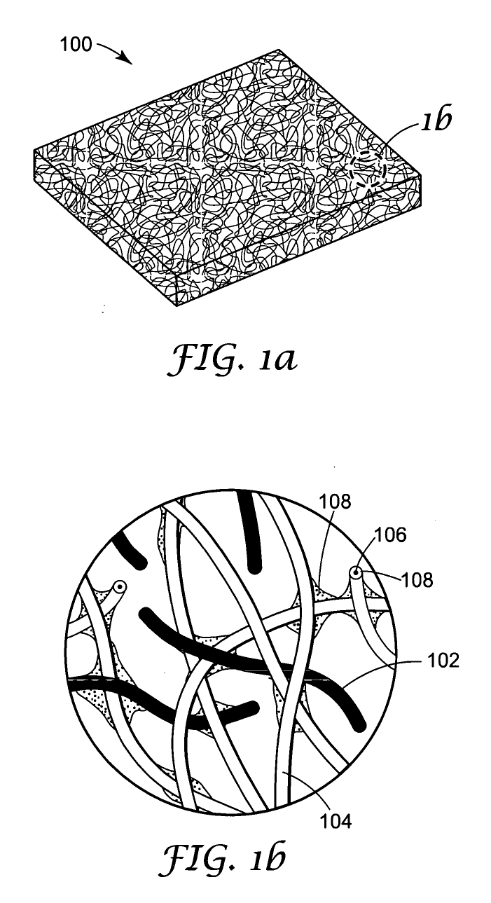

FIG. 1a is a perspective view of a web 100 of the present invention, and FIG. 1b is an enlarged view of the metal web 100 of FIG. 1a. The web 100 comprises metal fibers 102 and polymeric fibers 104. The metal fibers 102 and polymeric fibers 104 are blended together so that the web 100 has a random distribution of the metal fibers and polymeric fibers 104. Typically, the web 100 includes at least 50% (wt.) of metal fibers 102. The web 100 may include at least 75% (wt.) metal fibers 102 or at least 85% (wt.) metal fibers 102.

The metal fibers 102 can include any type of metal fibers such as but not limited to steel, stainless steel, copper, brass, or bronze. The metal fibers 102 are cut and are typically at least 0.5 inches (1.27 cm) long and have a thickness from 25 to 90 microns. Preferably, stainless steel is used because it is harder than other metal fibers like copper and bronze and is more corrosions resistant than steel wool.

The polymeric fibers 104 may be a single component fiber or a multi component fiber. Regardless, the polymeric fibers 104 include a portion that is capable of securing with the other fibers (metal or polymeric) to hold the fibers together and form the web. A single component fiber may be made from polypropylene. In such a case, the polymeric fiber is heated to a point that the polymeric fiber begins to melt. The fiber then attaches to other fibers (polymeric or melt) and upon cooling, solidifies and secures the fibers to form the web.

A multicomponent fiber is a fiber having at least two discrete portions. A multicomponent fiber is shown in FIG. 1b. One portion of the fiber 104 remains in tact and another portion of the fiber secures the polymeric fibers 104 and metal fibers 102 together to form a web. One type of multicomponent fiber is a core/sheath fiber and is shown in FIG. 1b. Reference will be made in the description to a core/sheath multicomponent fiber. However, it is understood that other types of multicompnent fibers are available.

The polymeric fibers 104 include a core 106 and a sheath 108 covering at least a portion of the core 106 prior to processing. It is understood that the sheath 108, prior to processing, may cover the entire core or only a portion of the core. The core 106 may be comprised of such materials as polypropylene or polyester. The sheath 108 may be comprised of such materials as copolyester or polyethylene. The core 106 has a first melting point and the sheath 108 has a second melting point. The second melting point of the sheath is lower than the first melting point of the core. During processing, the sheath with the second melting point will melt, while the core remains intact. Then, the material of the sheath will resolidify to secure the web together.

Typically, the polymeric fibers 104 are at least 1 inch (2.54 cm) long and have a denier of at least 2. Preferably, the polymeric fibers 104 are 1.5 inches (3.81 cm) long and have a denier of 12. One polymeric fiber 104 including a core and a sheath is Celbond® fibers 254, available from KoSa Co. of Wichita, Kansas where the sheath 108 has a melting point of 110° C.

Other multicomponent polymeric fibers are within the scope of the present inventions. Other multi-component fibers may consist of a layered structure where one layer has a first melting point and another layer has a second melting point lower than the first melting point. In such an arrangement, the layer with the second melting point will melt and resolidify to secure the web together. Also, a polymeric fiber with a core and an adhesive surrounding at least a portion of the core, resulting in a fiber with tack, may be used as the polymeric fiber. In such a case, the adhesive exterior of the polymeric fiber secures the web together.

Under processing, the sheath 108 of the polymeric fibers 104 melts and upon cooling reforms in a solid state to secure with the metal fibers 102 and other polymeric fibers 104. During melting, the sheath 108 tends to collect at junction points where metal fibers 102 and polymeric fibers 104 intersect. Therefore, as shown in FIG. 1b, a portion of the polymeric fiber 104, and in this embodiment the sheath 108 secures the metal fibers 102 and polymeric fibers 104 to form the web 100. By including a polymeric fiber 104 having a portion capable of securing with the other polymeric fibers 104 and the metal fibers 102, there is not a need for a separate binder to form the web 100.

The reconfigured sheath 108 of the polymeric fiber 104 will typically contact and attach portions of metal fibers 102 and other polymeric fibers 104 in contact with that particular polymeric fiber 104. Therefore, the entire surface of the metal fibers 102 will not be covered or in contact with the sheath 108 of the polymeric fiber 104. These exposed portions of the metal fibers 102 are then accessible for scouring, abrading, or otherwise contacting a working surface.

However, a portion of the metal fiber 102 is covered with the reconfigured sheath 108 of the polymeric fibers 104. Therefore, these portions covered will be “soft” to the touch of the user so that overall the web has less piercing impact on the hand of a user as compared to a purely metal web.

Additionally, the polymeric fibers 104 being distributed throughout the metal fibers 102 and randomly contacting and attaching the metal fibers 102 helps minimize portions of the metal fibers 102 from breaking free from the web 100. As can be seen in FIG. 1b, a single metal fiber 102 may have several contact points with the polymeric fiber 104 to assist with anchoring the metal fiber 102 to the web. Therefore, web 100 of the present invention sheds less metallic splinters as compared to a purely metal web.

By blending the metal fibers 102 with polymeric fibers 104, the overall need for metal fibers within the web is minimized. In other words, the polymeric fibers 104 dilute the metal fibers 102, and overall less metal fibers 102 are used in the web 100. Typically, stainless steel has been a preferred material because of its scouring and polishing ability and because it does not rust. However, stainless steel is relatively expensive compared to steel for example. The web 100 of the present invention allows for incorporation of stainless steel into a low cost web because the amount of metal (stainless steel) is diluted by the polymeric fibers.

The web 100 of the present invention may be used as a generally planar article as shown in FIG. 1. However, it is common to corrugate webs to help enhance the scouring of the web. It is within the scope of the present invention that the web 100 may be corrugated or have other three dimensional geometric patterns, such as circles, diamonds, rectangles, and squares.

The web 100 of the present invention may be used alone or in combination with various support layers and substrates. If used alone, further processing may be required to provide structural integrity to the web 100. For example, the web 100 may be coated with a binder resin over a single surface or may be coated with a binder resin on a portion of a surface of the web 100. The web 100 may be needlepunched, also known as needletacked, to provide structural integrity to the web 100.

In addition to metal fibers 102 and polymeric fibers 104, additional fibers may be included in the web such as but not limited to staple fibers such as polyester and nylon, or ceramic fibers, carbon fibers, or natural fibers. The web 100 may also be preloaded with detergent, soap, bleach, perfumes, colorants, antibacterial or antifungal chemicals or other known types of materials.

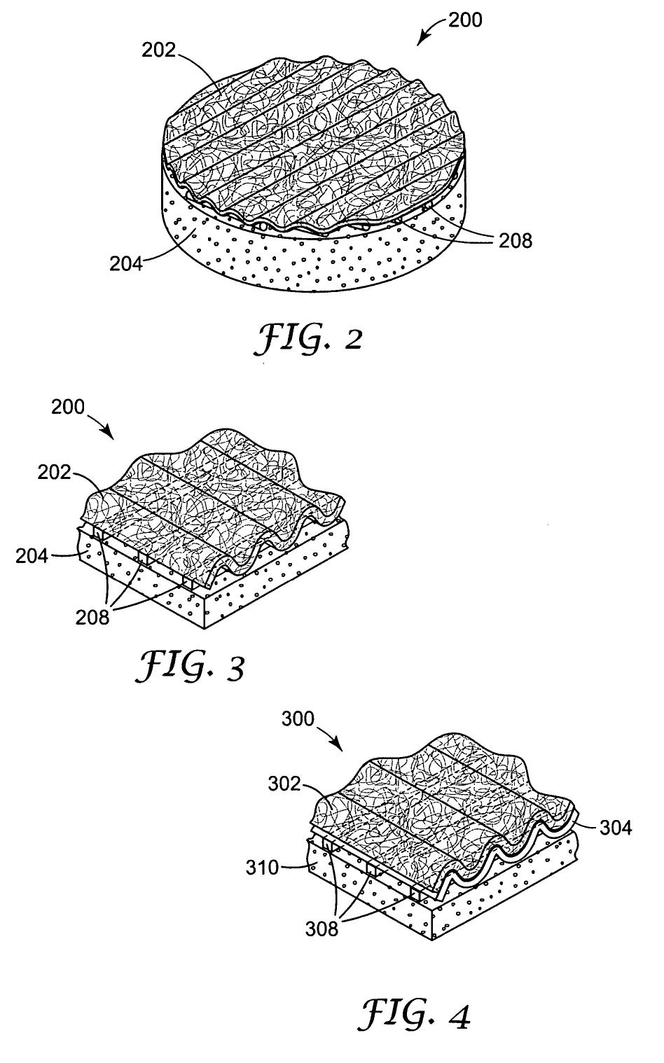

FIG. 2 is a perspective view of a scouring article 200 having a metal web 202, similar to that shown and described in FIG. 1a and FIG. 1b, attached to a support layer 204. Although the web 202 is similar in structure and composition as that shown and described in FIG. 1a and FIG. 1b, the web 202 of FIG. 2 is corrugated.

The web 202 is attached to the support layer 204 through any known attaching mechanism such as, but not limited to, needletacking, hydroentangling, heat bonding, ultrasonic bonding, and binding through adhesive, or any combination thereof depending on the substrate. A binding layer may include a coating of adhesive covering the entire support layer 204 or a portion of it. A binding layer may include discrete strands of binder 208, such as that shown in FIG. 2. Examples of binding layers between the web 202 and the support layer 204 are disclosed in U.S. patent applicaton Ser. No. 10/093,792, filed on Mar. 8, 2002, which is herein incorporated by reference.

The discrete strands of binder 208 are typically parallel strands that extend along the web 202 in a direction perpendicular to the corrugation of the web 202, as shown in FIG. 2. Therefore, the discrete strands of binder 208 prevent the corrugation of the web 202 from pulling apart and also secure the web 202 to the support layer 204. The discrete strands of binder 208 are preferably made of a material that will attach the web 202 and the support layer 204 together and will bend and flex with the scouring article 200. In a preferred embodiment, the discrete strands of binder 208 are propylene (7C50 available from DOW Chemical of Midland, Michigan). The discrete strands of binder 208 may be polypropylene or polyester.

The side of the web 202 opposite the support layer 204 is the exposed surface of the web 202 for scouring. When the discrete strands of binder 208 are included, the open spaces between the discrete strands of binder 208 allow for fluid to pass from the support layer 204 to the web 202 and vice versa. When the scouring article is used for cleaning, water along with soap or detergent may easily pass from the support layer 204 to the web 202. For such applications, the support layer 204 or the web 202 may be preloaded with a soap or detergent to assist with cleaning.

The support layer 204 used to support the web 202 may be any material, which will aid in holding and touching the support layer 204 and minimizing skin contact directly with the web 202. The support layer 204 is preferably flexible. Suitable substrates include, but are not limited to, sponges, woven, nonwoven, paper, foamed polyurethane and other foamed synthetic and natural materials and other such materials.

Typically, the support layer 204 and the web 202 are of the same size and shape as shown in FIG. 2. However, any shape, size, or configuration of the support layer 204 and web 202 may be used. For example, the web 202 may extend beyond the support layer 204 or may wrap around a portion of the support layer 204 and therefore cover more than one surface of the support layer 204. In another example, the web 202 may cover two or more surfaces of the support layer 204.

The scouring article 200 shown in FIG. 2 is intended to be held in a user's hand. Therefore, a shape and size that is ergonomically appropriate for hand-held use is preferred. For example, a circular scouring article may have a diameter of 4 inches (10.2 cm). The overall thickness is dependent on the support layer used. If a water absorbent, sponge-like backing is used, typically the scouring article will have a thickness of less than 3 inches (7.6 cm). In another example, the scouring article may be generally rectangular with a width of at least three inches and a length of at least 4 inches (10.2 cm).

The scouring article 200 may be configured to secure to a handle. Additionally, the scouring article 200 may be configured to secure to a handle that delivers soap or a detergent to the support layer 204 and therefore to the web 202 and working surface.

FIG. 3 is a cross-sectional view of the scouring article of FIG. 2. As shown, the scouring article 200 includes the web 202 that is corrugated and the support layer 204. The web 202 is attached to the support layer 204 with a binding layer that comprises discrete strands of binder 208. FIG. 3 clearly shows that the discrete strands of binder 208 cover discrete segments between the web 202 and support layer 204. Therefore, open space exists that would easily allow water or other fluid to pass from the support layer 204 to the web 202 and therefore to the working surface. The water or other fluid may carry soap or detergent that also can be delivered to the working surface.

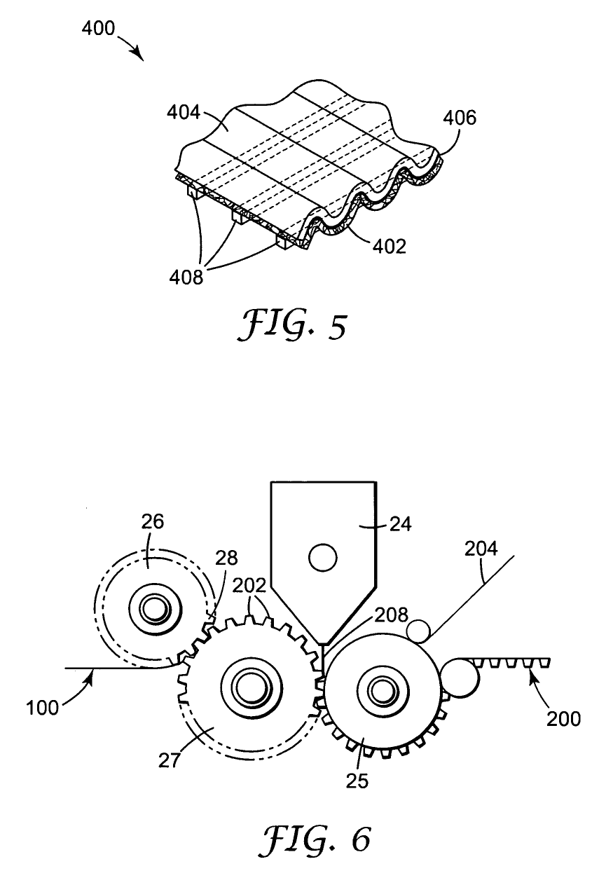

FIG. 4 is a cross-sectional view of an alternative scouring article 300. The scouring article 300 includes a web 302, a support layer 304 attached to the web 302, and a substrate 310 attached to the support layer 304 by a binding layer comprising discrete strands of binder 308. The web 302 is substantially similar to the web 100 shown and described in FIG. 1. However, the web 302 is preferably corrugated.

The support layer 304 supports the web 302 and provides structural strength and reinforcement to the web 302. The support layer 304 is attached to the web 302 by any known attachment mechanisms and in this embodiment is attached to the web 302 by needletacking. The support layer 304 is corrugated along with the web 302 (as will be discussed with reference to FIG. 6) and therefore has the same corrugation pattern as the web 302. The support layer 304 may be any known material that will attach to and support the web 302 such as, but not limited to, foam, woven, nonwoven material, film, foamed polyurethane and other foamed synthetic and natural materials. For the construction shown in the embodiment of FIG. 4, preferably the support layer 304 is a thin, flexible nonwoven. The side of the web 302 opposite the support layer 304 is exposed for scouring.

The substrate 310 is attached to the support layer 304 on the side of the support layer 304 opposite the web 302. The substrate 310 can be any material such as foam, woven or nonwoven material, foamed polyurethane and other foamed synthetic and natural materials. In this embodiment, a binding layer comprising discrete strands of binder 308 attaches the substrate 310 to the support layer 304. The discrete strands of binder 308 are typically spaced from one another and extend in a direction perpendicular to the folded direction of the corrugation, as shown in FIG. 4. The discrete strands of binder 308 are typically flexible to provide flexibility to the overall scouring article 300.

FIG. 5 is a cross-sectional view of an alternative scouring article 400. The scouring article 400 includes a web 402, a support layer 404 attached to the web 402, and discrete strands of binder 408. The web 402 is substantially similar to the web 100 shown and described in FIG. 1. However, the web 402 is preferably corrugated.

The support layer 404 supports the web 402 and provides structural strength and reinforcement to the web 402. In this embodiment, the support layer 404 is attached to the web 402 by a binding layer 406. The binding layer 406 in this embodiment is an adhesive coating over substantially the entire surface of the support layer 404. The support layer 404 is corrugated in the same pattern as the corrugation of the web 402. The support layer 404 may be any known material that will attach to and support the web 402 such as, but not limited to, foam, woven and nonwoven material, foamed polyurethane and other foamed synthetic and natural materials. For the construction shown in the embodiment of FIG. 5, preferably the support layer 404 is a thin, flexible nonwoven.

In this embodiment, discrete strands of binder 408 are attached to the web 402 on the side of the web 402 opposite the support layer 404. The discrete strands of binder 408 are typically spaced from one another and extend in a direction perpendicular to the folded direction of the corrugation, as shown in FIG. 5. The discrete strands of binder 408 are typically flexible to provide flexibility to the overall scouring article 400.

It is the exposed surface of the web 402 that is used for scouring. Although the scouring article 400 shown in FIG. 5 includes a support layer 404 on one surface and discrete strands of binder 408 on an opposite side, the discrete strands of binder 408 do not cover the entire surface of the web 402. The portions of the web 402 exposed through the gaps in the discrete strands of binder 408 are used for scouring. The density and width of the discrete strands of binder 408 determine the amount of web 402 exposed for scouring. The discrete strands of binder 402 assist with reinforcing the web 402 and further securing the metal fibers 102 within the web 402 to prevent splintering.

FIGS. 4 and 5 show alternative constructions of a scouring article. As with the scouring article 200 shown and described in FIG. 2, the scouring articles of FIGS. 4 and 5 can be of any size or shape. The scouring articles may be designed for hand-held use and therefore the portion contacting a user's hand can be of a material comfortable for touching. The scouring article may be designed for use with a handled tool.

For any of the scouring articles described, the support layers or substrates, if included, may be preloaded with detergent, soap, bleach, perfumes, antibacterial or antiftngal chemicals. The scouring articles may be firm and relatively rigid or may be relatively flexible.

The scouring articles described have at least one side of the web, similar to the web shown and described in FIG. 1a and FIG. 1b, exposed for scouring. The overall construction of the scouring article may be any combination of a web attached to a support layer. Any know attachment mechanism such as, but not limited to, needletacking, hydroentangling, or binding with adhesive. The binding layer may comprise an adhesive coating covering a portion or the entire substrate or the binding layer may be discrete strands of binder, or a combination thereof. Also, the portion of the polymeric fiber securing the web together may extend to the support layer to attach the web to the support layer. The particular attachment mechanism will depend on the support layer utilized, the concentration of polymeric fibers, and the end use application. Any one of these mechanisms or any combination of these mechanisms may be used to attach the web to the support layer and to attach the substrate, if included.

The support layer may be any known type of material such as foam, woven, nonwoven, paper, foamed polyurethane and other foamed synthetic and natural materials other similar material. Optionally, the scouring article may include additional substrate layers which may be any know type of material.

To scour a surface, a user may use a web similar in construction to the web shown and described in FIG. 1a and FIG. 1b and contact the surface to be scoured with the web.

Additionally, a scouring article may be used, such as shown in FIGS. 2-5, which includes an exposed web surface for contacting a surface to be scoured. In such a web or scouring article, the user may hold the web or scouring article or may attach it to a handled tool.

The present invention may be used to scour or abrade any number of surfaces.

Particularly, the present invention may be used to scour or abrade surfaces that are accommodating to steel wool pads or other such metal pads. Such surfaces include, but are not limited to metal and wood surfaces. One particular application of the web and scouring article of the present invention includes scouring metal pots, pans, and other kitchenware. In such an instance, the web and scouring article of the present invention scours and removes debris from the surface and polishes the metal. Another application of the web and scouring article of the present invention includes abrading and finishing wood surfaces during refinishing. Preferably, the metal fibers included in the web will not rust.

There are a number of suitable ways of making a web and a scouring article in accordance with the present invention. The web such as the web 100 shown in FIG. I may be formed using chopped metal fibers and polymeric fibers, which include a core and a sheath, on a “Rando Webber” machine (commercially available from Rando Machine Company, New York) or may be formed by other conventional processes. After the web is formed, the web may be needletacked to give added structural strength to the web. The web may then be heated to melt the sheath and then cooled to solidify the sheath of the polymeric fibers to form the web. It is understood that the same processing may occur in the event a single or other multicomponent fiber is used.

A method of making a scouring article, such as the scouring article 200 shown in FIG. 2, is generally shown in U.S. patent application Ser. No. 10/093,792, filed on Mar. 8, 2002, herein incorporated by reference. FIG. 6 is a side view of an exemplary process of making the scouring article of FIG. 1 and FIG. 2. FIG. 6 generally comprises forming a scouring article 200 by extruding a binding layer 208 between the web 100 and the support layer 204. The supplied web 100 may be a web formed from chopped metal fibers and polymeric fibers on a Rando Webber machine. The web 100 may be needletacked.

The method of making the scouring article shown in FIG. 6, is performed by providing first and second corrugating members or rollers 26, 27 each having an axis and including a plurality of circumferentially spaced generally axially extending ridges 28 around and defining its periphery, with spaces between the ridges 28 adapted to receive portions of the ridges 28 of the other corrugating member, 26 or 27, in meshing relationship with the web 100 between the meshed ridges 28. The corrugating members 26 and 27 are mounted in axially parallel relationship with portions of the ridges 28 meshing generally in the manner of gear teeth; at least one of the corrugating members 26 or 27 is rotated; and the web 100 is fed between the meshed portions of the ridges 28 of the corrugating members 26 and 27 to generally corrugate the web 100 to form a corrugated web 202. The corrugated web 202 is retained along the periphery of the second corrugating member 27 after it has moved past the meshed portions of the ridges 28.

The first and second corrugating rollers 26, 27 are preferably heated. The heat from the corrugating rollers serves to melt the sheath of the polymeric fibers in the web. Alternatively, a heat source may be included in the processing prior to the corrugating rollers 26, 27 after the web is formed.

A binding layer, which in this embodiment are discrete strands of binder 208, is extruded from a die 24 into a nip formed between the second corrugating member 27 and a cooling roller 25 while simultaneously supplying the support layer 204 into the nip formed between the second corrugating member 27 and the cooling roller 25 along the surface of cooling roller 25. It is understood that the die 24 can extrude a continuous stream of binder so that the binder layer covers the entire support layer surface or can extrude a plurality of discrete strands of binder. The discrete strands of binder 208 are deposited between the support layer 204 and the corrugated web 202 and bond the support layer 204 to the corrugated web 202.

The scouring article 200 is carried partially around the cooling roller 25 to complete cooling. The scouring article 200 is then converted into sizes and shapes for use.

It is understood that other arrangements of making a scouring article, such as those shown in FIG. 4 and 5 are within the scope of the present invention. Also, it is understood that various materials for the support layer and binding layer may be used.

Although specific embodiments of this invention have been shown and described herein, it is understood that these embodiments are merely illustrative of the many possible specific arrangements that can be devised in application of the principles of the invention. Numerous and varied other arrangements can be devised in accordance with these principles by those of ordinary skill in the art without departing from the spirit and scope of the invention. Thus, the scope of the present invention should not be limited to the structures described in this application, but only by the structures described by the language of the claims and the equivalents of those structures.

### EXAMPLES

### Example 1

A stainless steel loose fiber web was prepared in the following manner. A tow of stainless steel fiber (“Fine” stainless steel fiber, Product No. 161050, available from Global Metal Technologies, Palatine, Ill.), having an average diameter of 50 microns, was chopped into 0.5 inch (1.27 cm) length fibers by hand using a pair of scissors. The stainless steel fibers were then combined with a polyester/copolyester bicomponent binder fiber (Celbond® Type 254, 12 denier, cut length 1.5 inches, available from KoSa, Charlotte, N.C.) in an 85:15 weight ratio (stainless steel fiber:bicomponent fiber). A 200 gsm (grams per square meter) lofty nonwoven web approximately 15 mm (millimeters) thick was prepared from the fiber blend using an air lay machine available under the trade designation “RANDO WEBBER” from Rando Machine Corporation, Macedon, N.Y. The loose fiber web was then needletacked to consolidate the web to improve its handling strength for further processing by using a conventional needletacking apparatus (commercially available under the trade designation “DILO” from Dilo of Germany, with type #15×18×36×3.5 RB barbed needles (commercially available from Foster Needle Company, Inc. of Manitowoc, Wis.)) to provide about 15 punches per square centimeter. The barbed needles were punched through the full thickness of the web. After needletacking the web was about 5 mm thick.

The loose fiber web was then processed using the method and equipment illustrated in FIG. 6. The web was fed into the nip between first and second intermeshing corrugation rolls 26, 27, which were machined with axially parallel ridges spaced such that there were approximately 4 ridges per centimeter with a groove between each ridge. The corrugation rolls were heated to 295° F. (146° C.) and the nip pressure was 150 pli. The patterned web was shaped such that there were raised regions or peaks and anchor portions that formed valleys along the nonwoven web, each raised region or peak being about 1.5 mm high and each anchor portion being about 2 mm wide. After passing through the corrugation rolls 26, 27, the corrugated web traveled along the surface corrugation roll 27 to the nip point between the second corrugation roll 27 and the chill roll 25. The corrugated web was then cooled by passing the web over chill roll 25. The temperature of chill roll 25 was about 50° F. (10° C.) and the nip pressure was about 150 pli. After corrugating, the web was approximately 2 mm thick. The web was then wound into master rolls for converting.

### Example 2

A stainless steel loose fiber web was prepared in the following manner. A tow of stainless steel fiber (“Fine” stainless steel fiber, Product No. 161050, available from Global Metal Technologies, Palatine, Ill.), having an average diameter of 50 microns, was chopped into 0.5 inch (1.27 cm) length fibers by hand using a pair of scissors. The stainless steel fibers were then combined with a polyester/copolyester bicomponent binder fiber (Celbond® Type 254, 12 denier, cut length 1.5 inches, available from KoSa, Charlotte, N.C.) and a 25 denier polyester staple fiber (product 694P available from Wellmann, Fort Mill, S.C.) at a weight ratio of 85:8:7 (stainless steel fiber:bicomponent fiber: polyester fiber). A 200 gsm lofty nonwoven web approximately 15 mm thick was prepared from the fiber blend using an air lay machine available under the trade designation “RANDO WEBBER” from Rando Machine Corporation, Macedon, N.Y. The loose fiber web was then needletacked to consolidate the web to improve its handling strength for further processing by using a conventional needletacking apparatus (commercially available under the trade designation “DILO” from Dilo of Germany, with type #15×18×36×3.5 RB barbed needles (commercially available from Foster Needle Company, Inc. of Manitowoc, Wis.)) to provide about 15 punches per square centimeter. The barbed needles were punched through the full thickness of the web. After needletacking the web was about 5 mm thick.

The loose fiber web was then processed using the method and equipment illustrated in FIG. 6. The web was fed into the nip between first and second intermeshing corrugation rolls 26, 27, which were machined with axially parallel ridges spaced such that there were approximately 4 ridges per centimeter with a groove between each ridge. The corrugation rolls 26, 27 were heated to 295° F. (146° C.) and the nip pressure was 150 pli. The patterned web was shaped such that there were raised regions or peaks and anchor portions that formed valleys along the nonwoven web, each raised region or peak being about 1.5 mm high and each anchor portion being about 2 mm wide. After passing through the corrugation rollers 26, 27, the corrugated web traveled along the surface of corrugation roll 27 to the nip point between the second corrugation 27 roll and the chill roll 25. The corrugated web was then cooled by passing the web over chill roll 25. The temperature of chill roll 25 was about 50° F. (10° C.) and the nip pressure was about 150 pli. After corrugating, the web was approximately 2 mm thick. The web was then wound into master rolls for converting.

### Example 3

A stainless steel loose fiber web was prepared in the following manner. A tow of stainless steel fiber (“Fine” stainless steel fiber, Product No. 161050, available from Global Metal Technologies, Palatine, Ill.), having an average diameter of 50 microns, was chopped into 0.5 inch (1.27 cm) length fibers by hand using a pair of scissors. The stainless steel fibers were then combined with a polyester/copolyester bicomponent binder fiber (Celbond® Type 254, 12 denier, cut length 1.5 inches, available from KoSa, Charlotte, N.C.) in an 85:15 weight ratio (stainless steel fiber:bicomponent fiber). A 200 gsm lofty nonwoven web approximately 15 mm thick was prepared from the fiber blend using an air lay machine available under the trade designation “RANDO WEBBER” from Rando Machine Corporation, Macedon, N.Y. To improve handling strength, the resulting web was attached to a 10 gsm nylon spun-bond nonwoven backing (available from Cerex Advance Fabrics, Cantonment, Fla.) using a conventional needletacking apparatus (commercially available under the trade designation “DILO” from Dilo of Germany, with type #15×18×36×3.5 RB barbed needles (commercially available from Foster Needle Company, Inc. of Manitowoc, Wis.)) to provide about 15 punches per square centimeter. The barbed needles were punched through the full thickness of the web. After needletacking the web was about 5 mm thick.

The loose fiber web, with the nylon spun-bond nonwoven backing attached was then processed using the method and equipment illustrated in FIG. 6. The web was fed into the nip (stainless steel fiber web side down) between first and second intermeshing corrugation rolls 26, 27, which were machined with axially parallel ridges spaced such that there were approximately 4 ridges per centimeter with a groove between each ridge. The corrugation rolls 26, 27 were heated to 295° F. (146° C.) and the nip pressure was 150 pli. The patterned web was shaped such that there were raised regions or peaks and anchor portions that formed valleys along the nonwoven web, each raised region or peak being about 1.5 mm high and each anchor portion being about 2.0 mm wide. After passing through the nip point, the corrugated web traveled along the surface of corrugation roll 27 to the nip point between the second corrugation roll 27 and the chill roll 25. The corrugated web was then laminated/bonded to 0.5 inch thick polyurethane foam (indicated by reference number 204) by extruding polypropylene 208 (7C50 polypropylene resin, available from Dow Chemical Company, Midland, Mich.) filaments onto the anchor portions of the corrugated web just prior to the nip point as the polyurethane foam was fed into the nip point from feed roll. The polypropylene was extruded through 0.83 mm diameter orifices to result in about 3.5 filaments per centimeter at a basis weight of about 55 gsm of web. The corrugated web was then cooled by passing the web over chill roll 25. The temperature of chill roll 25 was about 50° F. (10° C.) and the nip pressure was about 150 pli. After corrugating, the web was approximately 2 mm thick. The web was then wound into master rolls for converting.

### Example 4

A stainless steel loose fiber web was prepared in the following manner. A tow of stainless steel fiber (“Fine” stainless steel fiber, Product No. 161050, available from Global Metal Technologies, Palatine, Ill.), having an average diameter of 50 microns, was chopped into 0.5 inch (1.27 cm) length fibers by hand using a pair of scissors. The stainless steel fibers were then combined with a polyester/copolyester bicomponent binder fiber (Celbond® Type 254, 12 denier, cut length 1.5 inches, available from KoSa, Charlotte, N.C.) in a 85:15 weight ratio (stainless steel fiber:bicomponent fiber). A 200 gsm lofty nonwoven web approximately 5 mm thick was prepared from the fiber blend using an air lay machine available under the trade designation “RANDO WEBBER” from Rando Machine Corporation, Macedon, N.Y. A blend (50:50 weight ratio) of 25 denier polyester fiber (Wellman 694P available from Wellman Inc. of Fort Mill, S.C.) and a polyester/copolyester bicomponent binder fiber (Celbond® Type 254, 12 denier, cut length 1.5 inches, available from KoSa, Charlotte, N.C.) was carded using conventional carding equipment and then passed through an oven at 305° F. (152° C.) to prepare a 100 gsm thermal bonded web. The stainless steel loose fiber web and the thermal bonded web were then needletacked together using a conventional needletacking apparatus (commercially available under the trade designation “DILO” from Dilo of Germany, with type #15×18×36×3.5 RB barbed needles (commercially available from Foster Needle Company, Inc. of Manitowoc, Wis.)) to provide about 15 punches per square centimeter. The barbed needles were punched through the full thickness of the web. After needletacking the web was about 5 mm thick.

The loose fiber web was then processed using the method and equipment illustrated in FIG. 6. The web was fed into the nip (stainless steel fiber web side down) between first and second intermeshing corrugation rolls 26, 27 which were machined with axially parallel ridges spaced such that there were approximately 4 ridges per centimeter with a groove between each ridge. The corrugation rolls 26, 27 were heated to 295° F. (146° C.) and the nip pressure was 150 pli. The patterned web was shaped such that there were raised regions or peaks and anchor portions that formed valleys along the nonwoven web, each raised region or peak being about 1.5 mm high and each anchor portion being about 2 mm wide. After passing through the corrugation rolls 26, 27, the corrugated web traveled along the surface of corrugation roll 27 to the nip point between the second corrugation roll 27 and the chill roll 25. The corrugated web was then cooled by passing the web over chill roll 25. The temperature of chill roll 25 was about 50° F. (10° C.) and the nip pressure is about 150 pli. After corrugating, the web was approximately 2 mm thick. The web was then wound into master rolls for converting.

### Example 5

A loose fiber web was prepared in a manner identical to Example 2.

The loose fiber web was then processed using the method and equipment illustrated in FIG. 6. The web was fed into the nip (stainless steel fiber web side down) between first and second intermeshing corrugation rolls 26, 27, which were machined with axially parallel ridges spaced such that there were approximately 4 ridges per centimeter with a groove between each ridge. The corrugation rolls 26, 27 were heated to 295° F. and the nip pressure was 150 pli. The patterned web was shaped such that there were raised regions or peaks and anchor portions that formed valleys along the nonwoven web, each raised region or peak being about 1.5 mm high and each anchor portion being about 2 mm wide. After passing through the corrugation rolls 26, 27, the corrugated web traveled along the surface of corrugation roll 27 to the nip point between the second corrugation roll 27 and the chill roll 25. Polypropylene 28 (7C50 Polypropylene Resin, available from Dow Chemical Company, Midland, Mich.) filaments were then extruded onto the anchor portions of the corrugated web just prior to the nip point. The polypropylene was extruded through 0.83 mm diameter orifices to result in about 3.5 filaments per centimeter at a basis weight of about 55 gsm of web. The corrugated web was then cooled by passing the web over chill roll 25. The temperature of chill roll 25 was about 50° F. (10° C.) and the nip pressure was about 150 pli. After corrugating the web was approximately 2 mm thick. The web was then wound into master rolls for converting.

What is claimed is:

1. A method of making a scouring web comprising:
providing a plurality of metal fibers;
providing a plurality of polymeric fibers;
combining the metal fibers with the polymeric fibers;
heating the polymeric fibers so that at least a portion of the polymeric fibers melt; and
cooling the polymeric fibers to solidify the portion of the polymeric fibers that melted and to secure the blend of metal fibers and polymeric fibers together.

2. The method of claim 1, wherein the polymeric fibers are a multicomponent fiber.

3. The method of claim 1, wherein the polymeric fibers comprise a polymeric core surrounded by a polymeric sheath, wherein the polymeric sheath has a melting point lower than the polymeric core.

4. The method of claim 1, further comprising:
needletacking the web.

5. The method of claim 1, further comprising:
corrugating the web.

6. The method of claim 1, further comprising:
coating at least a portion of the web with a binder.

7. The method of claim 1, further comprising:
providing a support layer;
attaching the support layer to the web.

8. The method of claim 7, further comprising:
providing a substrate;
attaching the substrate to the support layer.

9. A method of making a scouring article comprising:
providing a plurality of metal fibers;
providing a plurality of polymeric fibers;
combining the metal fibers with the polymeric fibers;
heating the polymeric fibers so that at least a portion of the polymeric fibers melt;
attaching a support layer to the metal fibers and polymeric fibers; and
cooling the polymeric fibers to solidify the portion of the polymeric fibers that melted and to secure the blend of metal fibers and polymeric fibers together.

10. The method of claim 9, wherein the polymeric fibers are a multicomponent fiber.

11. The method of claim 9, wherein the support layer is laminated to the metal fibers and polymeric fibers.

12. The method of claim 9, wherein the support layer is needletacked to the metal fibers and polymeric fibers.

13. The method of claim 9, further comprising:
providing a substrate; and
attaching the substrate to the carrier layer.

14. A method of making a scouring article comprising:
providing a plurality of metal fibers;
providing a plurality of polymeric fibers;
combining the metal fibers with the polymeric fibers to form a web having a first surface and a second surface;
heating the polymeric fibers so that at least a portion of the polymeric fibers melt;
providing a support layer with a first surface and a second surface;
attaching the first surface of the support layer to the second surface of the web;
providing a substrate with a first surface and a second surface;
attaching the first surface of the substrate to the second surface of the support layer; and
cooling the polymeric fibers to solidify the portion of the polymeric fibers that melted and to secure the blend of metal fibers and polymeric fibers together.
